(19) United States
(12) Patent Application Publication
(10) Pub. No.: US 2026/0066677 A1
(43) Pub. Date: Mar. 5, 2026

(54) MULTI-BAY BATTERY PACK CHARGER WITH PSEUDO-PASSTHROUGH

(71) Applicant: MILWAUKEE ELECTRIC TOOL CORPORATION, Brookfield, WI (US)

(72) Inventors: Omid H. Shirazi, Wauwatosa, WI (US); Vishal Meyyappan, Milwaukee, WI (US); Michael R. Halverson, Greenfield, WI (US)

(21) Appl. No.: 19/308,640

(22) Filed: Aug. 25, 2025

Related U.S. Application Data
(60) Provisional application No. 63/688,137, filed on Aug. 28, 2024.
(60) Provisional application No. 63/704,632, filed on Oct. 8, 2024.

(51) Int. Cl. H02J 7/00; H02J 7/04

(52) U.S. Cl. CPC H02J 7/50; H02J 7/04; H02J 7/60; H02J 7/70; H02J 7/855

(57) ABSTRACT

A multi-bay battery pack charger may include a plurality of battery pack interfaces configured to removably receive a plurality of battery packs, a charging circuit electrically connected to the plurality of battery pack interfaces, a power output, a discharging circuit electrically connected between the plurality of battery pack interfaces and the power output, and an electronic processor electrically connected to the charging circuit and the discharging circuit. The electronic processor may be configured to, when a first battery pack and a second battery pack are removably received in the plurality of battery pack interfaces and a first condition is satisfied, charge the first battery pack using the charging circuit; and discharge the second battery pack using the discharging circuit.

### CROSS-REFERENCE TO RELATED APPLICATIONS

This application claims the benefit of U.S. Provisional Application No. 63/688,137 filed Aug. 28, 2024 and U.S. Provisional Application No. 63/704,632 filed Oct. 8, 2024. The entire disclosures of the above applications are incorporated by reference.

### FIELD

The present disclosure relates to battery pack chargers and, more particularly, to battery pack chargers capable of managing simultaneously charging and discharging of multiple battery packs.

### SUMMARY

Power tool battery packs are used at worksites to operate various power tools. The power tool battery packs can be recharged by plugging the power tool battery pack into a battery pack charger. Plugging in a battery pack charger into available outlets may reduce the number of outlets for other applications, for example, to charge Universal Serial Bus (USB) devices. Accordingly, there is a need for a multi-bay battery pack charger with pseudo-passthrough. Pseudo-passthrough may refer to features that allow a battery pack charger to simultaneously charge a battery pack while using another battery pack to power a device connected to the battery pack charger, ensuring continuous power delivery to the connected device during battery pack charging.

Battery pack chargers described herein provide a range of technical solutions to these and other technical challenges. For instance, the battery pack chargers described herein allow users to leverage existing portable power tool battery packs to charge various direct current (DC) or alternating current (AC) electrical devices. This capability offers significant technical benefits, as power tool battery packs may be engineered to deliver high power output and may be built to withstand demanding conditions, making them a robust and reliable power source. The portability of power tool battery packs allows the battery pack chargers to power a wide array of devices—from small electronics such as smartphones and laptops to larger AC-powered appliances and tools—without requiring access to a traditional power outlet. This ensures that the connected electrical devices can be powered even at remote job sites that have limited or no access to the electrical grid.

Moreover, battery pack chargers described herein may allow users to charge one battery pack while simultaneously using another to power connected electrical devices. This dual functionality provides significant technical advantages by maintaining continuous power delivery to connected devices while recharging the battery packs. This capability ensures a steady power supply is available for immediate use while also ensuring that the battery packs remain charged and ready for future operations, enhancing overall operational efficiency by minimizing or eliminating downtime for both the connected electrical devices and the battery packs.

Additionally, the battery pack chargers described herein may provide additional technical benefits by avoiding the parallel or series operation of the battery packs. Typically, operating battery packs in parallel or series configurations may require complex circuitry to balance the voltage and/or current of the battery packs. By employing a sequential charging and/or discharging approach, the battery pack chargers described herein allow for the use of simplified control circuitry, which may reduce the overall complexity and manufacturing costs associated with the battery pack chargers.

In some aspects, the techniques described herein relate to a multi-bay battery pack charger including: a plurality of battery pack interfaces configured to removably receive a plurality of battery packs; a charging circuit electrically connected to the plurality of battery pack interfaces; a power output; a discharging circuit electrically connected between the plurality of battery pack interfaces and the power output; and an electronic processor electrically connected to the charging circuit and the discharging circuit and configured to when a first battery pack and a second battery pack are removably received in the plurality of battery pack interfaces and a first condition is satisfied charge the first battery pack using the charging circuit; and discharge the second battery pack using the discharging circuit.

In some aspects, the techniques described herein relate to a multi-bay battery pack charger, wherein the first condition includes a determination that the charging circuit is connected to an external power source.

In some aspects, the techniques described herein relate to a multi-bay battery pack charger, wherein the discharging circuit further includes an alternating current output circuit and a direct current output circuit.

In some aspects, the techniques described herein relate to a multi-bay battery pack charger, wherein the electronic processor is further configured to disconnect the alternating current output circuit from the second battery pack in response to determining that the first condition is satisfied.

In some aspects, the techniques described herein relate to a multi-bay battery pack charger, wherein the electronic processor is further configured to determine a charge level of the second battery pack while the second battery pack is discharging; and in response to the charge level of the second battery pack falling below a threshold stop discharging the second battery pack using the discharging circuit, begin charging the second battery pack using the charging circuit, and begin discharging the first battery pack using the discharging circuit.

In some aspects, the techniques described herein relate to a multi-bay battery pack charger, wherein the electronic processor is further configured to sequentially charge the first battery pack and the second battery pack.

In some aspects, the techniques described herein relate to a multi-bay battery pack charger, wherein the electronic processor is further configured to sequentially discharge the first battery pack and the second battery pack.

In some aspects, the techniques described herein relate to a multi-bay battery pack charger, wherein the multi-bay battery pack charger further includes a direct current outlet port electrically connected to the discharging circuit; and the electronic processor is further configured to determine a charge level of the second battery pack while the second battery pack is discharging, and disable the direct current outlet port in response to determining that the charge level of the second battery pack is below a threshold.

In some aspects, the techniques described herein relate to a multi-bay battery pack charger, wherein the electronic processor is further configured to, in response to detecting a fault condition associated with the second battery pack stop discharging the second battery pack using the discharging circuit, and begin discharging the first battery pack using the discharging circuit.

In some aspects, the techniques described herein relate to a multi-bay battery pack charger, wherein the electronic processor is further configured to, in response to detecting a fault condition associated with the first battery pack, stop charging the first battery pack using the charging circuit.

In some aspects, the techniques described herein relate to a method for operating a multi-bay battery pack charger, including: determining that a first condition is satisfied; and in response to determining that the first condition is satisfied charging a first battery pack removably received in a first battery pack interface using a charging circuit electrically connected to the first battery pack interface and a second battery pack interface, and discharging a second battery pack removably received in the second battery pack interface using a discharging circuit electrically connected to the first battery pack interface and the second battery pack interface.

In some aspects, the techniques described herein relate to a method, wherein the first condition includes a determination that the charging circuit is connected to an external electrical power source.

In some aspects, the techniques described herein relate to a method, wherein the discharging circuit further includes an alternating current output circuit and a direct current output circuit.

In some aspects, the techniques described herein relate to a method, further including disconnecting the alternating current output circuit from the second battery pack in response to determining that the first condition is satisfied.

In some aspects, the techniques described herein relate to a method, further including determining that a charge level of the second battery pack while the second battery pack is discharging is below a threshold; and in response determining that the charge level of the second battery pack while the second battery pack is discharging is below the threshold stopping the discharging of the second battery pack using the discharging circuit, charging the second battery pack using the charging circuit, and discharging the first battery pack using the discharging circuit.

In some aspects, the techniques described herein relate to a method, further including sequentially charging the first battery pack and the second battery pack.

In some aspects, the techniques described herein relate to a method, further including sequentially discharging the first battery pack and the second battery pack.

In some aspects, the techniques described herein relate to a method, further including determining that a charge level of the second battery pack while the second battery pack is discharging is below a threshold; and disabling a direct current port electrically connected to the discharging circuit in response to determining that the charge level of the second battery pack is below the threshold.

In some aspects, the techniques described herein relate to a method, further including, in response to detecting a fault condition associated with the second battery pack stopping the discharging of the second battery pack using the discharging circuit; and discharging the first battery pack using the discharging circuit.

In some aspects, the techniques described herein relate to a method, further including, in response to detecting a fault condition associated with the first battery pack, stopping the charging of the first battery pack using the charging circuit.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is a perspective view of a multi-bay battery pack charger according to some examples.

FIG. 2 is a schematic of the multi-bay battery pack charger of FIG. 1 according to some examples.

FIG. 3 is a block diagram of the multi-bay battery pack charger of FIG. 1 according to some examples.

FIGS. 4-6 are flowcharts illustrating an example process for controlling operation of the multi-bay battery pack charger of FIG. 1 according to some examples.

In the drawings, reference numbers may be reused to identify similar and/or identical elements.

### DETAILED DESCRIPTION

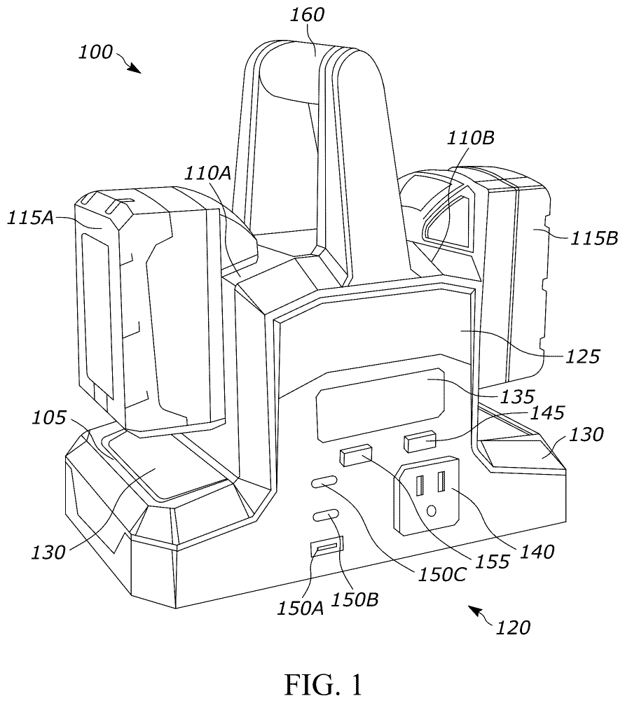

FIG. 1 illustrates an example multi-bay battery pack charger 100. The multi-bay battery pack charger 100 includes a charger housing 105, a plurality of battery pack interfaces 110 configured to removably receive a plurality of battery packs 115, and a user interface 120. The charger housing 105 includes a middle wall 125 and two base portions 130 extending from the middle wall 125 in opposite directions. The charger housing 105 also includes a handle 160 provided at a top portion of the middle wall 125. A first battery pack interface 110A is provided on a first side of the middle wall 125 (e.g., on a first side of the charger housing 105) and a second battery pack interface 110B is provided on a second side of the middle wall 125 (e.g., on a second side of the charger housing 105). The first battery pack interface 110A is configured to removably (e.g., slidably) receive a first battery pack 115A and the second battery pack interface 110B is configured to removably (e.g., slidably) receive a second battery pack 115B. Each of the plurality of battery pack interfaces 110 includes a terminal block including terminals (e.g., power terminals and communication terminals) to connect to the corresponding battery pack terminal blocks of the battery packs 115.

The battery packs 115 are, for example, power tool battery packs that are used to operate battery-powered power tools. In some examples, the battery packs 115 are 18 volt nominal voltage lithium-ion-chemistry-based power tool battery packs. In other examples, the battery packs 115 may have a different nominal voltage (e.g., 12 volts, 36 volts, 72 volts, and the like) and different chemistry (e.g., nickel based).

The user interface 120 is provided on a side surface of the housing 105 at a base of the middle wall 125 on a side adjacent the first side and the second side of the middle wall 125 as shown in FIG. 1. The user interface 120 includes a display 135, an AC outlet 140, an AC enable button 145, a plurality of DC outlets 150, and a DC enable button 155. The display 135 is, for example, an LCD display, an LED display, an e-ink display, or the like. The display 135 may provide indications regarding the status of the multi-bay battery pack charger 100. For example, the display 135 may show a fuel gauge relating to the battery packs 115, status of the outlets, and the like. The AC enable button 145 is, for example, a push button switch that can be used to enable and disable the AC outlet 140. While a single AC outlet 140 is illustrated in FIG. 1, other examples of the multi-bay battery pack charger 100 may include any number of AC outlets 140.

In the example illustrated, the plurality of DC outlets 150 includes three DC outlets: a first DC outlet 150A, a second DC outlet 150B, and a third DC outlet 150C. The first DC outlet 150A is a first type of DC outlet, for example, a Universal Serial Bus-C (USB-C) Power Delivery (PD) outlet configured to provide a power output at a maximum of about 100 watts. The second DC outlet 150B and the third DC outlet 150C are a second type of DC outlet, for example, a Universal Serial Bus-C (USB-C) outlet configured to provide a power output at a maximum of about 15 watts. While three DC outlets 150A-150C are illustrated in FIG. 1, other examples of the multi-bay battery pack charger 100 may include any number of (and any combination of types of) DC outlets 150. The DC enable button 155 is, for example, a push button switch that can be used to enable and disable the DC outlets 150.

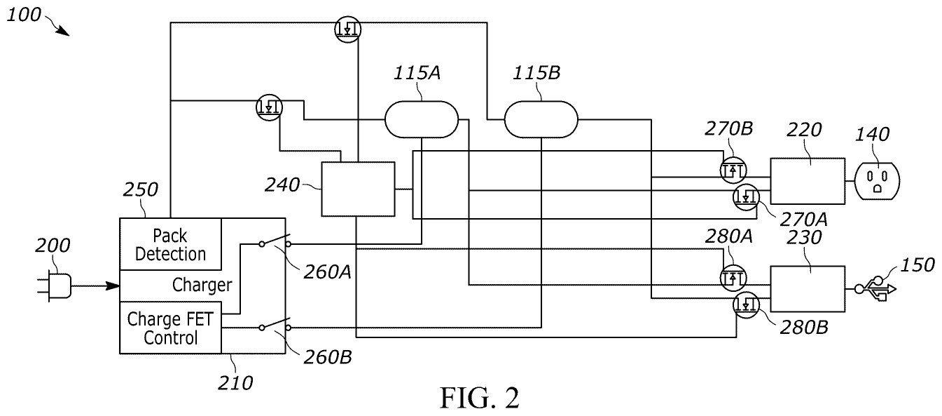

FIG. 2 is a schematic of the multi-bay battery pack charger 100 showing one example configuration. The multi-bay battery pack charger 100 includes a power input 200, a charging circuit 210, a DC-AC converter 220, a DC-DC converter 230, and a switch control module 240. The power input 200 includes, for example, a power cord that can be plugged into a wall outlet to receive power (such as, for example, external AC power) from an electrical grid or a power generator. The power input 200 is electrically connected to the charging circuit 210, which is electrically connected to the battery pack 115A and the battery pack 115B. The charging circuit 210 includes a pack detection module 250 configured to detect whether a battery pack 115 (such as battery pack 115A or battery pack 115B) is inserted into a respective battery pack interface 110. The charging circuit 210 also includes switches 260 (such as, for example, charging field effect transistors [FETs]) that selectively connect the charging circuit 210 to the battery pack interfaces 110 to charge the battery packs 115 received in the battery pack interfaces 110.

The charging circuit 210 may convert AC power from the power input 200 into DC power and provide DC power to the battery packs 115. For example, charging circuit 210 closes the switches 260 to sequentially charge the battery packs 115. To charge the battery pack 115A, the charging circuit 210 may close the switch 260A and open the switch 260B, completing the electrical circuit between the power input 200, charging circuit 210, and battery pack 115A while breaking the electrical circuit between the power input 200, charging circuit 210, and battery pack 115B. To charge battery pack 115B, the charging circuit may close the switch 260A and open the switch 260B, breaking the electrical circuit between the power input 200, charging circuit 210, and battery pack 115A while opening the electrical circuit between the power input 200, charging circuit 210, and battery pack 115B.

Electrical power may be provided from the battery packs 115 to the AC outlet 140 and/or DC outlets 150 via the DC-AC converter 220 and/or DC-DC converter 230, respectively. The DC-AC converter 220 may be electrically connected to the AC outlet 140 and the DC-DC converter 230 may be electrically connected to the DC outlet 150. The battery pack 115A may be electrically connected to the DC-AC converter 220 with a switch 270A positioned in series between the battery pack 115A and the DC-AC converter 220. The battery pack 115B may be electrically connected to the DC-AC converter 220 with a switch 270B positioned in series between the battery pack 115B and the DC-AC converter 220. The battery pack 115A may be electrically connected to the DC-DC converter 230 with a switch 280A positioned in series between the battery pack 115A and the DC-DC converter 230. The battery pack 115B may be electrically connected to the DC-DC converter 230 with a switch 280B positioned in series between the battery pack 115B and the DC-DC converter 230.

The DC-AC converter 220 is, for example, an inverter circuit that includes a power switching network in an inverter bridge (3-bridge) configuration. The DC-AC converter 220 converts DC power from the battery packs 115 received in the battery pack interfaces 110 to AC power provided at the AC outlet 140. The DC-AC converter 220 is configured to provide an AC output at about 400 Watts. Discharging switches 270 selectively electrically couple the battery pack interfaces 110 to the DC-AC converter 220. The DC-DC converter 230 converts DC power from the battery packs 115 at a first voltage to DC power provided to the DC outlets 150 at a second voltage. The DC-DC converter 230 is configured to provide power at about 100 Watts from the first DC outlet 150A and at about 15 Watts from each of the second DC outlet 150B and the third DC outlet 150C. The switches 270 may be FETs that selectively couple the battery pack interfaces 110 to the DC-AC converter 220. The switches 280 may be FETs that selectively electrically couple the battery pack interfaces 110 to the DC-DC converter 230.

A switch control module 240 is in communication with and configured to control the discharging switches 270 and the switches 280 as further explained below. The switch control module 240 is implemented by the controller 300 as further explained below. In various implementations, the switch control module 240 is in communication with and controls the switches 260, switches 270, and/or switches 280 to sequentially connect the battery packs 115A and 115B to the charging circuit 210 to sequentially charge the battery packs 115A and 115B such that only one battery pack 115 is charging at any given time. In some examples, the switch control module 240 is in communication with and controls the switches 260, switches 270, and/or switches 280 to sequentially connect the battery packs 115A and 115B to the AC outlet 140 (via the DC-AC converter 220) and/or the DC outlet 150 (via the DC-DC converter 230) such that only one battery pack 115 is discharging (power the AC outlet 140 and/or the DC outlets 150) at any given time.

When the AC outlet 140 is enabled (e.g., by the user actuating the AC enable button 145), the switch control module 240 closes the switches 270 to connect the DC-AC converter 220 to the battery packs 115. When the AC outlet 140 is disabled (e.g., by the user actuating the AC enable button 145), the switch control module 240 opens the switches 270 to disconnect the DC-AC converter 220 from the battery packs 115. When the DC outlets 150 are enabled (e.g., by the user actuating the DC enable button 155), the switch control module 240 closes the switches 280 to connect the DC-DC converter 230 to the battery packs 115. When the DC outlets 150 are enabled (e.g., by the user actuating the DC enable button 155), the switch control module 240 opens the switches 280 to disconnect the DC-DC converter 230 from the battery packs 115.

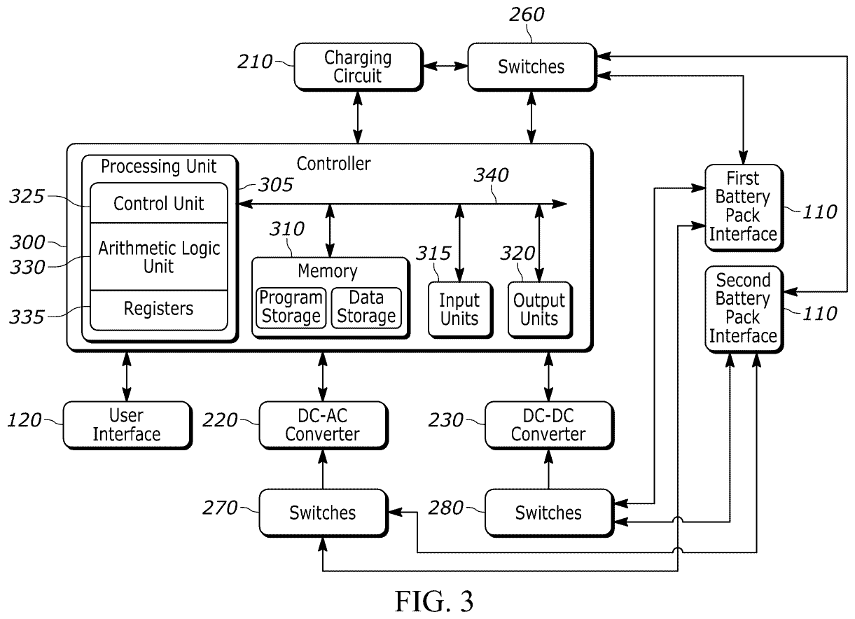

FIG. 3 is a schematic illustration of a controller 300 of the multi-bay battery pack charger 100. The controller 300 is electrically and/or communicatively connected to a variety of modules or components of the multi-bay battery pack charger 100. For example, the illustrated controller 300 is connected to the user interface 120, the charging circuit 210, the DC-AC converter 220, the DC-DC converter 230, the charging switches 260, the discharging switches 270, and the discharging switches 280. The controller 300 provides control signals to control the user interface 120, the charging circuit 210, the DC-AC converter 220, the DC-DC converter 230, the charging switches 260, the discharging switches 270, and the discharging switches 280.

The controller 300 includes combinations of hardware and software that are operable to, among other things, control the operation of the multi-bay battery pack charger 100. For example, the controller 300 includes, among other things, a processing unit 305 (e.g., a microprocessor, a microcontroller, an electronic processor, an electronic controller, or another suitable programmable device), a memory 310, input units 315, and output units 320. The processing unit 305 includes, among other things, a control unit 325, an arithmetic logic unit (“ALU”) 330, and a plurality of registers 335 (shown as a group of registers in FIG. 3) and is implemented using a known computer architecture (e.g., a modified Harvard architecture, a von Neumann architecture, etc.). The processing unit 305, the memory 310, the input units 315, and the output units 320, as well as the various modules or circuits connected to the controller 300 are connected by one or more control and/or data buses (e.g., common bus 340). The control and/or data buses are shown generally in FIG. 3 for illustrative purposes. Although the controller 300 is illustrated in FIG. 3 as one controller, the controller 300 could also include multiple controllers configured to work together to achieve a desired level of control for the multi-bay battery pack charger 100. As such, any control functions and processes described herein with respect to the controller 300 could also be performed by two or more controllers functioning in a distributed manner.

The memory 310 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 305 is connected to the memory 310 and is configured to execute software instructions that are capable of being stored in a RAM of the memory 310 (e.g., during execution), a ROM of the memory 310 (e.g., on a generally permanent basis), or another non-transitory computer readable medium such as another memory or a disc. Software included in the implementation of the multi-bay battery pack charger 100 and controller 300 can be stored in the memory 310 of the controller 300. The software includes, for example, firmware, one or more applications, program data, filters, rules, one or more program modules, and other executable instructions. The controller 300 is configured to retrieve from the memory 310 and execute, among other things, instructions related to the control processes and methods described herein. In other embodiments, the controller 300 includes additional, fewer, or different components.

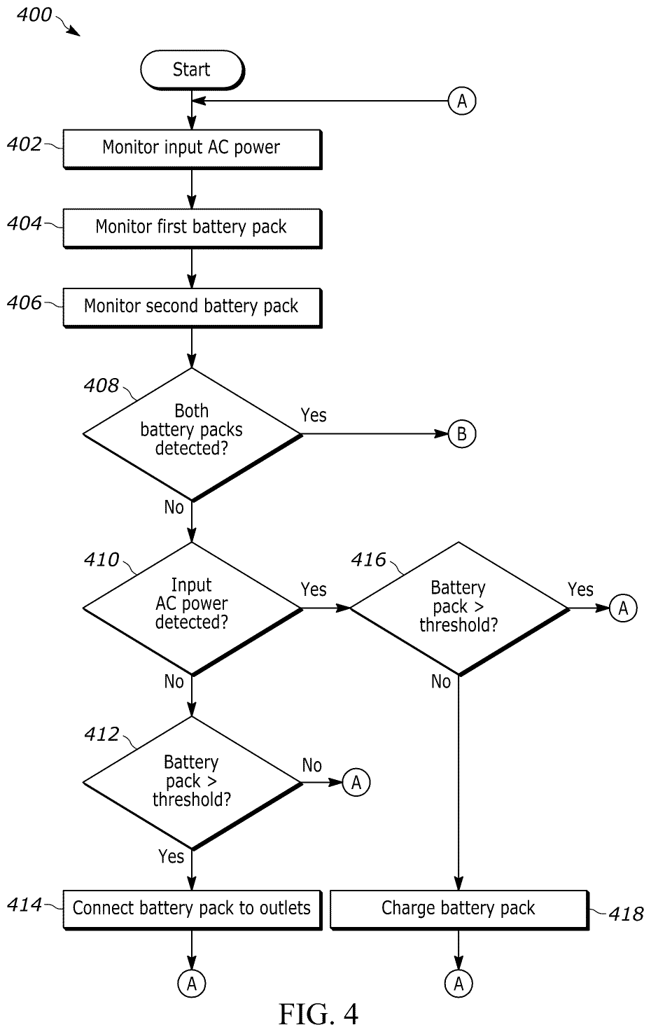

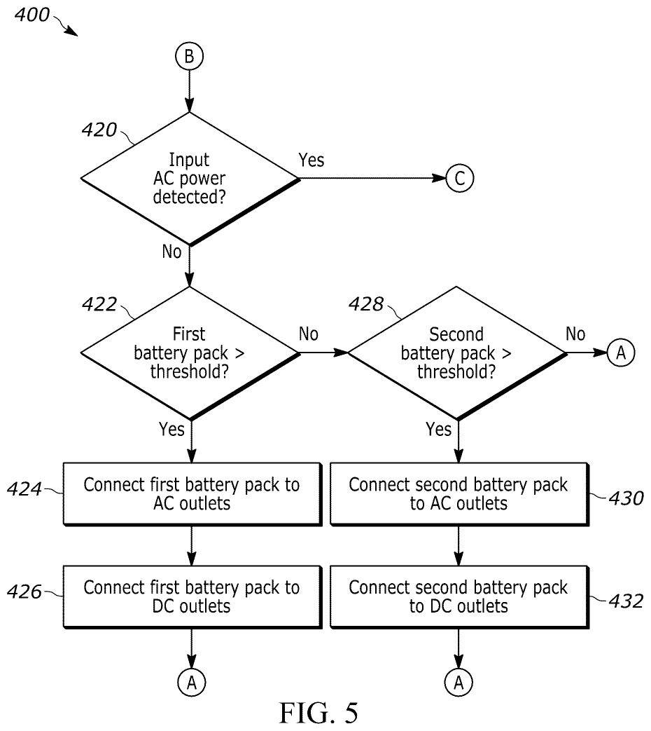

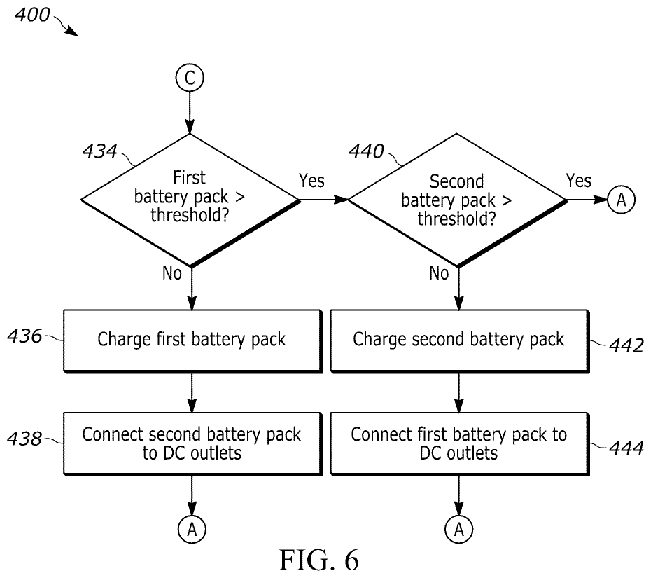

The controller 300 controls the charging switches 260 to charge the battery packs 115 received in the battery pack interfaces 110. The controller 300 charges the battery packs 115 received in the battery pack interfaces 110 sequentially such that only one battery pack 115 is being charged at one time. Additionally, the controller 300 operates the battery packs 115 independently, that is, neither in series nor in parallel. Rather, the controller 300 may operate the battery packs sequentially as further described with reference to FIGS. 4-6 and to the table below. While one battery pack 115 received in a battery pack interface 110 is being charged, the other battery pack 115 received in another battery pack interface 110 may be used to passthrough power to the AC outlet 140 and/or the DC outlets 150 (e.g., referred to as “pseudo-passthrough”). The controller 300 uses the discharging switches 270 to connect the non-charging battery pack 115 to the DC-AC converter and uses the discharging switches 280 to connect the non-charging battery pack 115 to the DC-DC converter. In one example, when the multi-bay battery pack charger 100 is plugged in (e.g., when the power input 200 is connected to external AC power), the controller 300 may disable the AC outlet 140 as an AC outlet or other external AC power source is already available to a user.

FIGS. 4-6 are flowcharts illustrating an example process 400 for controlling operation of the multi-bay battery pack charger 100, according to some examples. Although operations of the process 400 are illustrated with reference to particular examples described herein, the process 400 may be implemented in any suitable setting. Operations are illustrated once each and in a particular order in FIGS. 4-6, but the operations may be reordered and/or repeated as desired and appropriate. For example, different operations may be performed in parallel, as suitable. In the example process 400, the controller 300 monitors the charging circuit 210 to determine whether the multi-bay battery pack charger 100 is receiving input AC power via the power input 200 (at block 402). In the example process 400, the controller 300 monitors sensors at the first battery pack interface 110A and/or the battery pack detection module 250 to determine whether the first battery pack 115A is connected to the multi-bay battery pack charger 100 (at operation 404). The controller 300 may also monitor the sensors and/or the battery pack detection module 250 to determine a charge level of the battery pack 115A.

In the example process 400, the controller 300 monitors sensors at the second battery pack interface 110B and/or the battery pack detection module 250 to determine whether the second battery pack 115B is connected to the multi-bay battery pack charger 100 (at operation 406). The controller 300 may also monitor the sensors and/or the battery pack detection module 250 to determine a charge level of the battery pack 115B. In the example process 400, the controller 300 determines whether both battery packs 115A and 115B are detected (at decision block 408). Both battery packs 115A and 115B being detected may mean that both battery packs 115A and 115B are connected to the multi-bay battery pack charger 100 and available for sequential charging and/or sequential discharging (e.g., providing electrical power to the AC outlet 140 and/or DC outlets 150).

In response to both battery packs 115A and 115B not being detected (“NO” at decision block 408), the controller 300 determines whether input AC power is detected at the charging circuit 210 (at decision block 410). Input AC power being detected at the charging circuit 210 may mean that the power input 200 is connected to an external AC power source and that external AC power is available for charging the connected battery packs 115. In response to determining that input AC power is not detected (“NO” at decision block 410), the controller 300 determines whether the charge level of the connected battery pack 115 is above a first threshold (at decision block 412). The charge level of the connected battery pack 115 being above the first threshold may mean that the connected battery pack 115 is sufficiently charged and available for providing electrical power to the AC outlet 140 and/or the DC outlets 150, while the charge level of the connected battery pack 115 not being above the first threshold may mean that the connected battery pack 115 is not sufficiently charged and not available for providing electrical power to the AC outlet and/or DC outlets 150.

In response to determining that the charge level of the connected battery pack 115 is above the first threshold (“YES” at decision block 412), the controller 300 operates the switches 260, 270, and/or 280 to connect the connected battery pack 115 to the DC-AC converter 220 and/or DC-DC converter 230 to provide electrical power to the AC outlet 140 and/or DC outlets 150 (at block 414). The controller 300 may operate the switches 260, 270, and/or 280 to disconnect the connected battery pack 115 from the charging circuit 210. The controller 300 continues monitoring the input AC power at block 402. In response to determining that the charge level of the connected battery pack is not above the first threshold (“NO” at decision block 412), the controller 300 continues monitoring the input AC power at block 402. In response to determining that input AC power is detected (“YES” at decision block 410), the controller 300 determines whether the charge level of the connected battery pack 115 is above a second threshold (at decision block 416). The charge level of the connected battery pack 115 being above the second threshold may indicate that the connected battery pack 115 is sufficiently or fully charged or that charging is not necessary.

In response to determining that the charge level of the connected battery pack 115 is not above the second threshold (“NO” at decision block 416), the controller 300 controls the switches 260, 270, and/or 280 to connect the battery pack 115 to the charging circuit 210 and charges the battery pack 115 (at block 418). The controller 300 may operate the switches 260, 270, and/or 280 to disconnect the connected battery pack 115 from the DC-AC converter 220 and the DC-DC converter 230. The controller 300 continues monitoring the input AC power at block 402. In response to determining that the charge level of the connected battery is above the second threshold (“YES” at decision block 416), the controller 300 continues monitoring the input AC power at block 402. In response to the controller 300 determining that both battery packs 115A and 115B are detected (“YES” at decision block 408), the controller 300 determines whether input AC power is detected (at decision block 420). In response to determining that input AC power is not detected (“NO” at decision block 420), the controller 300 determines whether the charge level of the first battery pack 115A is greater than the first threshold (at decision block 422). The charge level of the first battery pack 115A being greater than the first threshold may mean that the first battery pack 115A is available for providing electrical power to the AC outlet 140 and/or DC outlets 150, while the charge level of the first battery pack 115A not being greater than the first threshold may indicate that the first battery pack 115A is not available for providing electrical power to the AC outlet 140 and/or DC outlets 150.

In response to determining that the charge level of the first battery pack 115A is greater than the first threshold (“YES” at decision block 422), the controller 300 operates the switches 260, 270, and/or 280 to connect the first battery pack 115A to the DC-AC converter 220 to provide electrical power to the AC outlet 140 (at block 424). The controller 300 may operate the switches 260, 270, and/or 280 to disconnect the first battery pack 115A from the charging circuit 210 and disconnect the second battery pack from the DC-AC converter 220 and the DC-DC converter 230. In the example process 400, the controller 300 operates the switches 260, 270, and/or 280 to connect the first battery pack 115A to the DC-DC converter 230 to provide electrical power to the DC outlets 150 (at block 426). The controller 300 continues monitoring the input AC power at block 402.

In response to determining that the charge level of the first battery pack 115A is not above the first threshold (“NO” at decision block 422), the controller 300 determines whether the charge level of the second battery pack 115B is greater than the first threshold (at decision block 428). The charge level of the second battery pack 115B being greater than the first threshold may mean that the second battery pack 115B is available for providing electrical power to the AC outlet 140 and/or DC outlets 150, while the charge level of the second battery pack 115B not being greater than the first threshold may indicate that the second battery pack 115B is not available for providing electrical power to the AC outlet 140 and/or DC outlets 150.

In response to determining that the charge level of the second battery pack 115B is greater than the first threshold (“YES” at decision block 428), the controller 300 operates the switches 260, 270, and/or 280 to connect the second battery pack 115B to the DC-AC converter 220 to provide electrical power to the AC outlet 140 (at block 430). The controller 300 may operate the switches 260, 270, and/or 280 to disconnect the second battery pack 115B from the charging circuit 210 and disconnect the first battery pack 115 from the DC-AC converter 220 and the DC-DC converter 230. In the example process 400, the controller 300 operates the switches 260, 270, and/or 280 to connect the second battery pack 115B to the DC-DC converter 230 to provide electrical power to the DC outlets 150 (at block 432). The controller 300 continues monitoring the input AC power at block 402. In response to determining that the charge level of the second battery pack 115B is not above the second threshold (“NO” at decision block 428), the controller 300 continues monitoring the input AC power at block 402.

In response to determining that input AC power is detected (“YES” at decision block 420), the controller 300 determines whether the charge level of the first battery pack 115A is greater than the second threshold (at decision block 434). The charge level of the first battery pack 115A being greater than the second threshold may mean that the first battery pack 115A is charged, while the charge level of the first battery pack 115A not being greater than the second threshold may mean that the first battery pack 115A needs charging. In response to determining that the charge level of the first battery pack 115A is not greater than the second threshold (“NO” at decision block 434), the controller 300 operates the switches 260, 270, and/or 280 to connect the first battery pack 115A to the charging circuit 210 and charge the first battery pack 115A (at block 436). The controller 300 may operate the switches 260, 270, and/or 280 to disconnect the first battery pack 115A from the DC-AC converter 220 and DC-DC converter 230 and disconnect the second battery pack 115B from the charging circuit 210. In the example process 400, the controller 300 operates the switches 260, 270, and/or 280 to connect the second battery pack 115B to DC-DC converter 230 to provide electrical power to the DC outlets 150 (at block 438). The controller 300 continues monitoring the input AC power at block 402.

In response to determining that the charge level of the first battery pack 115A is greater than the second threshold (“YES” at decision block 434), the controller 300 determines whether the charge level of the second battery pack 115B is greater than the second threshold (at decision block 440). The charge level of the second battery pack 115B being greater than the second threshold may mean that the second battery pack 115B is charged, while the charge level of the second battery pack 115B not being greater than the second threshold may mean that the second battery pack 115B needs charging. In response to determining that the charge level of the second battery pack 115B is not greater than the second threshold (“NO” at decision block 440), the controller 300 operates the switches 260, 270, and/or 280 to connect the second battery pack 115B to the charging circuit 210 and charge the second battery pack 115B (at block 442). The controller 300 may operate the switches 260, 270, and/or 280 to disconnect the second battery pack 115B from the DC-AC converter 220 and DC-DC converter 230 and disconnect the first battery pack 115A from the charging circuit 210. In the example process 400, the controller 300 operates the switches 260, 270, and/or 280 to connect the first battery pack 115A to DC-DC converter 230 to provide electrical power to the DC outlets 150 (at block 444). The controller 300 continues monitoring the input AC power at block 402. In response to determining that the charge level of the second battery pack 115B is greater than the second threshold (“YES” at decision block 440), the controller 300 continues monitoring the input AC power at block 402.

In various implementations, the controller 300 controls the switches 260, the switches 270, and the switches 280 according to the state transitions described below in Table 1:

TABLE 1

| Power | Battery | Battery | AC | DC | | Power | Battery | Battery | AC | DC |
|---|---|---|---|---|---|---|---|---|---|---|
| Input | Pack | Pack | Outlet | Outlets | | Input | Pack | Pack | Outlet | Outlets |
| 200 | 115A | 115B | 140 | 150 | Change | 200 | 115A | 115B | 140 | 150 |
| No | DC Outlets | Waiting | No | Yes | Connect | Yes | DC Outlets | Charging | No | Yes |
| | 150 | | | | power | | 150 | | | |
| | Waiting | DC Outlets | | | input 200 | | Charging | DC Outlets | | |
| | | 150 | | | | | | 150 | | |
| | Discharging | Waiting | Yes | | | | DC Outlets | Charging | Yes | |
| | | | | | | | 150 | | | |
| | Waiting | Discharging | | | | | Charging | DC Outlets | | |
| | | | | | | | | 150 | | |
| Yes | DC Outlets | Charging | No | Yes | Disconnect | No | DC Outlets | Waiting | No | Yes |
| | 150 | | | | power | | 150 | | | |
| | Charging | DC Outlets | | | input 200 | | Waiting | DC Outlets | | |
| | | 150 | | | | | | 150 | | |
| | DC Outlets | Charging | Yes | | | | Discharging | Waiting | Yes | |
| | 150 | | | | | | | | | |
| | Charging | DC Outlets | | | | | Waiting | Discharging | | |
| | | 150 | | | | | | | | |
| Yes | Charging | No | No | Yes | Insert | Yes | Charging | DC Outlets | No | Yes |
| | | | | | pack | | | 150 | | |
| | No | Charging | | | | | DC Outlets | Charging | | |
| | | | | | | | 150 | | | |
| | Charging | No | Yes | | | | Charging | DC Outlets | Yes | |
| | | | | | | | | 150 | | |
| | No | Charging | | | | | DC Outlets | Charging | | |
| | | | | | | | 150 | | | |
| Yes | Charging | DC Outlets | No | Yes | Remove | Yes | Charging | No | No | Yes |
| | | 150 | | | discharging | | | | | |
| | DC Outlets | Charging | | | pack | | No | Charging | | |
| | 150 | | | | | | | | | |
| | Charging | DC Outlets | Yes | | | | Charging | No | Yes | |
| | | 150 | | | | | | | | |
| | DC Outlets | Charging | | | | | No | Charging | | |
| | 150 | | | | | | | | | |
| Yes | Charging | DC Outlets | No | Yes | Remove | Yes | No | DC Outlets | No | Yes |
| | | 150 | | | charging | | | 150 | | |
| | DC Outlets | Charging | | | pack | | DC Outlets | No | | |
| | 150 | | | | | | 150 | | | |
| | Charging | DC Outlets | Yes | | | | No | DC Outlets | Yes | |
| | | 150 | | | | | | 150 | | |
| | DC Outlets | Charging | | | | | DC Outlets | No | | |
| | 150 | | | | | | 150 | | | |
| Yes | Charging | DC Outlets | No | Yes | Pack | Yes | Waiting | DC Outlets | No | Yes |
| | | 150 | | | charged/ | | | 150 | | |
| | DC Outlets | Charging | | | charge | | DC Outlets | Waiting | | |
| | 150 | | | | fault | | 150 | | | |
| | Charging | DC Outlets | Yes | | | | Waiting | DC Outlets | Yes | |
| | | 150 | | | | | | 150 | | |
| | DC Outlets | Charging | | | | | DC Outlets | Waiting | | |
| | 150 | | | | | | 150 | | | |
| Yes | Charging | DC Outlets | No | Yes | Pack low/ | Yes | Charging | Waiting | No | Yes |
| | | 150 | | | discharge | | | | | |
| | DC Outlets | Charging | | | fault | | Waiting | Charging | | |
| | 150 | | | | | | | | | |
| | Charging | DC Outlets | Yes | | | | Charging | Waiting | Yes | |
| | | 150 | | | | | | | | |
| | DC Outlets | Charging | | | | | Waiting | Charging | | |
| | 150 | | | | | | | | | |
| Yes | Waiting | DC Outlets | No | Yes | Pack low/ | Yes | DC Outlets | Charging | No | Yes |
| | | 150 | | | discharge | | 150 | | | |
| | DC Outlets | Waiting | | | fault | | Charging | DC Outlets | | |
| | 150 | | | | | | | 150 | | |
| | Waiting | DC Outlets | Yes | | | | DC Outlets | Charging | Yes | |
| | | 150 | | | | | 150 | | | |
| | DC Outlets | Waiting | | | | | Charging | DC Outlets | | |
| | 150 | | | | | | | 150 | | |
| Yes | Charging | Waiting | No | Yes | Pack | Yes | DC Outlets | Charging | No | Yes |
| | | | | | charged/ | | 150 | | | |
| | Waiting | Charging | | | charge | | Charging | DC Outlets | | |
| | | | | | fault | | | 150 | | |
| | Charging | Waiting | Yes | | | | DC Outlets | Charging | Yes | |
| | | | | | | | 150 | | | |
| | Waiting | Charging | | | | | Charging | DC Outlets | | |
| | | | | | | | | 150 | | |
| Yes | Charging | Waiting | No | No | DC outlets | Yes | Charging | DC Outlets | No | Yes |
| | | | | | 150 | | | 150 | | |
| | Waiting | Charging | | | enabled | | DC Outlets | Charging | | |
| | | | | | | | 150 | | | |
| | Charging | Waiting | Yes | | | | Charging | DC Outlets | Yes | |
| | | | | | | | | 150 | | |
| | Waiting | Charging | | | | | DC Outlets | Charging | | |
| | | | | | | | 150 | | | |
| Yes | Charging | DC Outlets | No | Yes | DC outlets | Yes | Charging | Waiting | No | No |
| | | 150 | | | 150 | | | | | |
| | DC Outlets | Charging | | | disabled | | Waiting | Charging | | |
| | 150 | | | | | | | | | |
| | Charging | DC Outlets | Yes | | | | Charging | Waiting | Yes | |
| | | 150 | | | | | | | | |
| | DC Outlets | Charging | | | | | Waiting | Charging | | |
| | 150 | | | | | | | | | |
| Yes | Charging | DC Outlets | No | Yes | Both packs | Yes | Charging | Waiting | No | No |
| | | 150 | | | low | | | | | |
| | DC Outlets | Charging | | | | | Waiting | Charging | | |
| | 150 | | | | | | | | | |
| | Charging | DC Outlets | Yes | | | | Charging | Waiting | Yes | |
| | | 150 | | | | | | | | |
| | DC Outlets | Charging | | | | | Waiting | Charging | | |
| | 150 | | | | | | | | | |

Table 1 illustrates examples of logical conditions according to which the controller 300 triggers new states for the switches 260, 270, and/or 280 according to changes in conditions at the multi-bay battery pack charger 100. In the following examples, the battery packs 115A and 115B charge and discharge (e.g., provide power to the outlets) sequentially such that one battery pack 115 is charging at any given time and only one battery pack 115 is discharging at any given time. A battery pack 115 that is charging may be connected to the charging circuit 210 and disconnected from the DC-AC converter 220 and the DC-DC converter 230. A battery pack that is discharging may be connected to the AC outlet 140 via the DC-AC converter 220 and/or the DC outlets 150 via the DC-DC converter 230, and disconnected from the charging circuit 210.

In various implementations, the power input 200 is initially not connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B is waiting to charge or provide power. In response to the power input 200 being connected to external AC power, the controller 300 controls the switches 260, 270, and/or 280 so that the battery pack 115A continues providing power to the DC outlets 150 while the battery pack 115B charges.

In some examples, the power input 200 is initially not connected to external AC power, both battery packs 115A and 115B are connected to the respective battery pack interface 110, the AC outlet 140 is disabled, and the DC outlets 150 are enabled. Initially, the battery pack 115A is waiting to charge or provide power while the battery pack 115B is providing power to the DC outlets 150. In response to the power output 200 being connected to external AC power, the controller 300 controls the switches 260, 270, and/or 280 so that the battery pack 115A charges while the battery pack 115B continues providing power to the DC outlets 150.

In various implementations, the power input 200 is initially not connected to external AC power, both battery packs 115A and 115B are connected to the respective battery pack interface 110, the AC outlet 140 is enabled, and the DC outlets 150 are enabled. Initially, the battery pack 115A is providing power to the AC outlet 140 and the DC outlets 150 while the battery pack 115B is waiting to charge or provide power. In response to the power input 200 being connected to external AC power, the controller 300 controls the switches 260, 270, and/or 280 so that the battery pack 115A is disconnected from the AC outlet 140 but continues providing power to the DC outlets 150 while the battery pack 115B charges.

In some examples, the power input 200 is initially not connected to external AC power, both battery packs 115A and 115B are connected to the respective battery pack interface 110, the AC outlet 140 is enabled, and the DC outlets 150 are enabled. Initially, the battery pack 115A is waiting to charge or provide power while the battery pack 115B is providing power to the AC outlet 140 and the DC outlets 150. In response to the power input 200 being connected to external AC power, the controller 300 controls the switches 260, 270, and/or 280 so that the battery pack 115A charges while the battery pack 115B is disconnected from the AC outlet 140 but continues providing power to the DC outlets 150.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B charges. In response to the power input 200 being disconnected from external AC power, the controller 300 controls the switches 260, 270, and/or 280 so that the battery pack 115A continues providing power to the DC outlets 150 while the battery pack 115B waits to provide power or charge.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B is providing power to the DC outlets 150. In response to the power input 200 being disconnected from external AC power, the controller 300 controls the switches 260, 270, and/or 280 so that the battery pack 115A waits to provide power or charge while the battery pack 115B continues providing power to the DC outlets 150.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is providing power to the DC outlets 150 while the battery pack 115B is charging. In response to the power input 200 being disconnected from external AC power, the controller 300 controls the switches 260, 270, and/or 280 so that the battery pack 115A provides power to the AC outlet 140 and the DC outlets 150 while the battery pack 115B waits to provide power or charge.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B is providing power to the DC outlets 150. In response to the power input 200 being disconnected from external AC power, the controller 300 controls the switches 260, 270, and/or 280 so that the battery pack 115A waits to provide power or charge while the battery pack 115B provides power to the AC outlet 140 and the DC outlets 150.

In various implementations, the power input 200 is initially connected to external AC power, the battery pack 115A is connected to the battery pack interface 110A, the battery pack 115B is not connected to the battery pack interface 110B, the AC outlet 140 is disabled, and the DC outlets 150 are enabled. Initially, the battery pack 115A is charging. In response to the battery pack 115B being connected to the battery pack interface 110B, the controller 300 controls the switches 260, 270, and/or 280 so that the battery pack 115A continues charging while the battery pack 115B provides power to the DC outlets 150.

In some examples, the power input 200 is initially connected to external AC power, the battery pack 115A is not connected to the battery pack interface 110A, the battery pack 115B is connected to the battery pack interface 110B, the AC outlet 140 is disabled, and the DC outlets 150 are enabled. Initially, the battery pack 115B is charging. In response to the battery pack 115A being connected to the battery pack interface 110A, the controller 300 controls the switches 260, 270, and/or 280 so that the battery pack 115A provides power to the DC outlets 150 while the battery pack 115B continues charging.

In various implementations, the power input 200 is initially connected to external AC power, the battery pack 115A is connected to the battery pack interface 110A, the battery pack 115B is not connected to the battery pack interface 110B, the AC outlet 140 is enabled, and the DC outlets 150 are enabled. Initially, the battery pack 115A is charging. In response to the battery pack 115B being connected to the battery pack interface 110B, the controller 300 controls the switches 260, 270, and/or 280 so that the battery pack 115A continues charging while the battery pack 115B provides power to the DC outlets 150.

In some examples, the power input 200 is initially connected to external AC power, the battery pack 115A is not connected to the battery pack interface 110B, the battery pack 115B is connected to the battery pack interface 110B, the AC outlet 140 is enabled, and the DC outlets 150 are enabled. Initially, the battery pack 115B is charging. In response to the battery pack 115A being connected to the battery pack interface 110A, the controller 300 controls the switches 260, 270, and/or 280 so that the battery pack 115A provides power to the DC outlets 150 while the battery pack 115B charges.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B is providing power to the DC outlets 150. In response to the battery pack 115B (the discharging battery pack) being removed, the controller 300 controls the switches 260, 270, and/or 280 so that the battery pack 115A continues charging.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B is charging. In response to the battery pack 115A (the discharging battery pack) being removed, the controller 300 controls the switches 260, 270, and/or 280 so that the battery pack 115B continues charging.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B is providing power to the DC outlets 150. In response to the battery pack 115B (the discharging battery pack) being removed, the controller 300 controls the switches 260, 270, and/or 280 so that the battery pack 115A continues charging.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A is providing power to the DC outlets 150 while the battery pack 115B is charging. In response to the battery pack 115A (the discharging battery pack) being removed, the controller 300 controls the switches 260, 270, and/or 280 so that the battery pack 115B continues charging.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B is providing power to the DC outlets 150. In response to the battery pack 115A (the charging battery pack) being removed, the controller 300 controls the switches 260, 270, and/or 280 so that the battery pack 115B continues providing power to the DC outlets 150.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B is charging. In response to the battery pack 115B (the charging battery pack) being removed, the controller 300 controls the switches 260, 270, and/or 280 so that the battery pack 115A continues providing power to the DC outlets 150.

In various implementations, the power input 200 is initially connected to external AC power, both battery packs 115A and 115B are connected to the respective battery pack interface 110, the AC outlet 140 are enabled, and the DC outlets 150 are enabled. Initially, the battery pack 115A is charging while the battery pack 115B is providing power to the DC outlets 150. In response to the battery pack 115A (the charging battery pack) being removed, the controller 300 controls the switches 260, 270, and/or 280 so that the battery pack 115B continues providing power to the DC outlets 150.

In some examples, the power input 200 is initially connected to external AC power, both battery packs 115A and 115B are connected to the respective battery pack interface 110, the AC outlet 140 are enabled, and the DC outlets 150 are enabled. Initially, the battery pack 115A is providing power to the DC outlets 150 while the battery pack 115B is charging. In response to the battery pack 115B (the charging battery pack) being removed, the controller 300 controls the switches 260, 270, and/or 280 so that the battery pack 115A continues providing power to the DC outlets 150.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B is providing power to the DC outlets 150. In response to detecting that the battery pack 115A (the charging battery pack) is charged or a charging fault is present, the controller 300 controls the switches 260, 270, and/or 280 so that the battery pack 115A waits to provide power or charge while the battery pack 115B continues providing power to the DC outlets 150.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B is charging. In response to detecting that the battery pack 115B (the charging battery pack) is charged or a charging fault is present, the controller 300 controls the switches 260, 270, and/or 280 so that the battery pack 115A continues providing power to the DC outlets 150 while the battery pack 115B waits to provide power or charge.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B is providing power to the DC outlets 150. In response to detecting that the battery pack 115A (the charging battery pack) is charged or a charging fault is present, the controller 300 controls the switches 260, 270, and/or 280 so that the battery pack 115A waits to provide power or charge while the battery pack 115B continues providing power to the DC outlets 150.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A is providing power to the DC outlets 150 while the battery pack 115B is charging. In response to detecting that the battery pack 115B (the charging battery pack) is charged or a charging fault is present, the controller 300 controls the switches 260, 270, and/or 280 so that the battery pack 115A continues providing power to the DC outlets 150 while the battery pack 115B waits to provide power or charge.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B is providing power to the DC outlets 150. In response to detecting that the battery pack 115B (the discharging battery pack) is in a low charge state or a discharging fault is present, the controller 300 controls the switches 260, 270, and/or 280 so that the battery pack 115A continues to charge while the battery pack 115B waits to provide power or charge.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B is charging. In response to detecting that the battery pack 115A (the discharging battery pack) is in a low charge state or a discharging fault is present, the controller 300 controls the switches 260, 270, and/or 280 so that the battery pack 115A waits to provide power or charge while the battery pack 115B continues to charge.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B is providing power to the DC outlets 150. In response to detecting that the battery pack 115B (the discharging battery pack) is in a low charge state or a discharging fault is present, the controller 300 controls the switches 260, 270, and/or 280 so that the battery pack 115A continues to charge while the battery pack 115B waits to provide power or charge.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A is providing power to the DC outlets 150 while the battery pack 115B is charging. In response to detecting that the battery pack 115A (the discharging battery pack) is in a low charge state or a discharging fault is present, the controller 300 controls the switches 260, 270, and/or 280 so that the battery pack 115A waits to provide power or charge while the battery pack 115B continues to charge.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is waiting to charge or discharge while the battery pack 115B is providing power to the DC outlets 150. In response to detecting that the battery pack 115B (the discharging battery pack) is in a low charge state or a discharging fault is present, the controller 300 controls the switches 260, 270, and/or 280 so that the battery pack 115A powers the DC outlets 150 while the battery pack 115B charges.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is providing power to the DC outlets 150 while the battery pack 115B is waiting to charge or discharge. In response to detecting that the battery pack 115A (the discharging battery pack) is in a low charge state or a discharging fault is present, the controller 300 controls the switches 260, 270, and/or 280 so that the battery pack 115A charges while the battery pack 115B powers the DC outlets 150.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is waiting to charge or discharge while the battery pack 115B is providing power to the DC outlets 150. In response to detecting that the battery pack 115B (the discharging battery pack) is in a low charge state or a discharging fault is present, the controller 300 controls the switches 260, 270, and/or 280 so that the battery pack 115A powers the DC outlets 150 while the battery pack 115B charges.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A is providing power to the DC outlets 150 while the battery pack 115B is waiting to charge or discharge. In response to detecting that the battery pack 115A (the discharging battery pack) is in a low charge state or a discharging fault is present, the controller 300 controls the switches 260, 270, and/or 280 so that the battery pack 115A charges while the battery pack 115B powers the DC outlets 150.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B is waiting to charge or discharge. In response to detecting that the battery pack 115A (the charging battery pack) is charged or that a charging fault is present, the controller 300 controls the switches 260, 270, and/or 280 so that the battery pack 115A powers the DC outlets 150 while the battery pack 115B charges.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A is waiting to charge or discharge while the battery pack 115B is charging. In response to detecting that the battery pack 115B (the charging battery pack) is charged or that a charging fault is present, the controller 300 controls the switches 260, 270, and/or 280 so that the battery pack 115A charges while the battery pack 115B powers the DC outlets 150.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B is waiting to charge or discharge. In response to detecting that the battery pack 115A (the charging battery pack) is charged or that a charging fault is present, the controller 300 controls the switches 260, 270, and/or 280 so that the battery pack 115A powers the DC outlets 150 while the battery pack 115B charges.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A is waiting to charge or discharge while the battery pack 115B is charging. In response to detecting that the battery pack 115B (the charging battery pack) is charged or that a charging fault is present, the controller 300 controls the switches 260, 270, and/or 280 so that the battery pack 115A charges while the battery pack 115B powers the DC outlets 150.

In various implementations, the power input 200 is initially connected to external AC power, both battery packs 115A and 115B are connected to the respective battery pack interface 110, the AC outlet 140 is disabled, and the DC outlets 150 are disabled. Initially, the battery pack 115A is charging while the battery pack 115B is waiting to charge or discharge. In response to the DC outlets 150 being enabled, the controller 300 controls the switches 260, 270, and/or 280 so that the battery pack 115A continues charging while the battery pack 115B powers the DC outlets 150.

In some examples, the power input 200 is initially connected to external AC power, both battery packs 115A and 115B are connected to the respective battery pack interface 110, the AC outlet 140 is disabled, and the DC outlets 150 are disabled. Initially, the battery pack 115A is waiting to charge or discharge while the battery pack 115B is charging. In response to the DC outlets 150 being enabled, the controller 300 controls the switches 260, 270, and/or 280 so that the battery pack 115A powers the DC outlets 150 while the battery pack 115B continues charging.

In various implementations, the power input 200 is initially connected to external AC power, both battery packs 115A and 115B are connected to the respective battery pack interface 110, the AC outlet 140 is enabled, and the DC outlets 150 are disabled. Initially, the battery pack 115A is charging while the battery pack 115B is waiting to charge or discharge. In response to the DC outlets 150 being enabled, the controller 300 controls the switches 260, 270, and/or 280 so that the battery pack 115A continues charging while the battery pack 115B powers the DC outlets 150.

In some examples, the power input 200 is initially connected to external AC power, both battery packs 115A and 115B are connected to the respective battery pack interface 110, the AC outlet 140 is enabled, and the DC outlets 150 are disabled. Initially, the battery pack 115A is waiting to charge or discharge while the battery pack 115B is charging. In response to the DC outlets 150 being enabled, the controller 300 controls the switches 260, 270, and/or 280 so that the battery pack 115A powers the DC outlets 150 while the battery pack 115B continues charging.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B powers the DC outlets 150. In response to the DC outlets 150 being disabled, the controller 300 controls the switches 260, 270, and/or 280 so that the battery pack 115A continues charging while the battery pack 115B is disconnected from the DC outlets 150 and waits to charge or discharge.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A powers the DC outlets 150 while the battery pack 115B is charging. In response to the DC outlets 150 being disabled, the controller 300 controls the switches 260, 270, and/or 280 so that the battery pack 115A is disconnected from the DC outlets 150 and waits to charge or discharge while the battery pack 115B continues charging.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B powers the DC outlets 150. In response to the DC outlets 150 being disabled, the controller 300 controls the switches 260, 270, and/or 280 so that the battery pack 115A continues charging while the battery pack 115B is disconnected from the DC outlets 150 and waits to charge or discharge.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A powers the DC outlets 150 while the battery pack 115B is charging. In response to the DC outlets 150 being disabled, the controller 300 controls the switches 260, 270, and/or 280 so that the battery pack 115A is disconnected from the DC outlets 150 and waits to charge or discharge while the battery pack 115B continues charging.

In various implementations, the power input 200 is initially connected to external AC power, both battery packs 115A and 115B are connected to the respective battery pack interface 110, the AC outlet 140 is disabled, and the DC outlets 150 are enabled. Initially, the battery pack 115A is charging while the battery pack 115B powers the DC outlets 150. In response to detecting that both battery packs 115A and 115B have a low charge state, the controller 300 controls the switches 260, 270, and/or 280 so that the battery pack 115A continues charging while the battery pack 115B is disconnected from the DC outlets 150 and waits to charge or discharge.

In some examples, the power input 200 is initially connected to external AC power, both battery packs 115A and 115B are connected to the respective battery pack interface 110, the AC outlet 140 is disabled, and the DC outlets 150 are enabled. Initially, the battery pack 115A powers the DC outlets 150 while the battery pack 115B is charging. In response to detecting that both battery packs 115A and 115B have a low charge state, the controller 300 controls the switches 260, 270, and/or 280 so that the battery pack 115A is disconnected from the DC outlets 150 and waits to charge or discharge while the battery pack 115B continues charging.

In various implementations, the power input 200 is initially connected to external AC power, both battery packs 115A and 115B are connected to the respective battery pack interface 110, the AC outlet 140 is enabled, and the DC outlets 150 are enabled. Initially, the battery pack 115A is charging while the battery pack 115B powers the DC outlets 150. In response to detecting that both battery packs 115A and 115B have a low charge state, the controller 300 controls the switches 260, 270, and/or 280 so that the battery pack 115A continues charging while the battery pack 115B is disconnected from the DC outlets 150 and waits to charge or discharge.

In some examples, the power input 200 is initially connected to external AC power, both battery packs 115A and 115B are connected to the respective battery pack interface 110, the AC outlet 140 is enabled, and the DC outlets 150 are enabled. Initially, the battery pack 115A powers the DC outlets 150 while the battery pack 115B is charging. In response to detecting that both battery packs 115A and 115B have a low charge state, the controller 300 controls the switches 260, 270, and/or 280 so that the battery pack 115A is disconnected from the DC outlets 150 and waits to charge or discharge while the battery pack 115B continues charging.

Thus, embodiments described herein provide, among other things, a multi-bay battery pack charger with pseudo-passthrough.

What is claimed is:

1. A multi-bay battery pack charger comprising:
a plurality of battery pack interfaces configured to removably receive a plurality of battery packs;
a charging circuit electrically connected to the plurality of battery pack interfaces;
a power output;
a discharging circuit electrically connected between the plurality of battery pack interfaces and the power output; and
an electronic processor electrically connected to the charging circuit and the discharging circuit and configured to
when a first battery pack and a second battery pack are removably received in the plurality of battery pack interfaces and a first condition is satisfied
charge the first battery pack using the charging circuit; and
discharge the second battery pack using the discharging circuit.

2. The multi-bay battery pack charger of claim 1, wherein the first condition includes a determination that the charging circuit is connected to an external power source.

3. The multi-bay battery pack charger of claim 2, wherein the discharging circuit further comprises an alternating current output circuit and a direct current output circuit.

4. The multi-bay battery pack charger of claim 3, wherein the electronic processor is further configured to disconnect the alternating current output circuit from the second battery pack in response to determining that the first condition is satisfied.

5. The multi-bay battery pack charger of claim 1, wherein the electronic processor is further configured to
determine a charge level of the second battery pack while the second battery pack is discharging; and
in response to the charge level of the second battery pack falling below a threshold
stop discharging the second battery pack using the discharging circuit,
begin charging the second battery pack using the charging circuit, and
begin discharging the first battery pack using the discharging circuit.

6. The multi-bay battery pack charger of claim 1, wherein the electronic processor is further configured to sequentially charge the first battery pack and the second battery pack.

7. The multi-bay battery pack charger of claim 1, wherein the electronic processor is further configured to sequentially discharge the first battery pack and the second battery pack.

8. The multi-bay battery pack charger of claim 1, wherein
the multi-bay battery pack charger further comprises a direct current outlet port electrically connected to the discharging circuit; and
the electronic processor is further configured to
determine a charge level of the second battery pack while the second battery pack is discharging, and
disable the direct current outlet port in response to determining that the charge level of the second battery pack is below a threshold.

9. The multi-bay battery pack charger of claim 1, wherein the electronic processor is further configured to, in response to detecting a fault condition associated with the second battery pack
stop discharging the second battery pack using the discharging circuit, and
begin discharging the first battery pack using the discharging circuit.

10. The multi-bay battery pack charger of claim 1, wherein the electronic processor is further configured to, in response to detecting a fault condition associated with the first battery pack, stop charging the first battery pack using the charging circuit.

11. A method for operating a multi-bay battery pack charger, comprising:
determining that a first condition is satisfied; and
in response to determining that the first condition is satisfied
charging a first battery pack removably received in a first battery pack interface using a charging circuit electrically connected to the first battery pack interface and a second battery pack interface, and
discharging a second battery pack removably received in the second battery pack interface using a discharging circuit electrically connected to the first battery pack interface and the second battery pack interface.

12. The method of claim 11, wherein the first condition includes a determination that the charging circuit is connected to an external electrical power source.

13. The method of claim 12, wherein the discharging circuit further comprises an alternating current output circuit and a direct current output circuit.

14. The method of claim 13, further comprising disconnecting the alternating current output circuit from the second battery pack in response to determining that the first condition is satisfied.

15. The method of claim 11, further comprising
determining that a charge level of the second battery pack while the second battery pack is discharging is below a threshold; and
in response determining that the charge level of the second battery pack while the second battery pack is discharging is below the threshold
stopping the discharging of the second battery pack using the discharging circuit,
charging the second battery pack using the charging circuit, and
discharging the first battery pack using the discharging circuit.

16. The method of claim 11, further comprising sequentially charging the first battery pack and the second battery pack.

17. The method of claim 11, further comprising sequentially discharging the first battery pack and the second battery pack.

18. The method of claim 11, further comprising
determining that a charge level of the second battery pack while the second battery pack is discharging is below a threshold; and
disabling a direct current port electrically connected to the discharging circuit in response to determining that the charge level of the second battery pack is below the threshold.

19. The method of claim 11, further comprising, in response to detecting a fault condition associated with the second battery pack
stopping the discharging of the second battery pack using the discharging circuit; and
discharging the first battery pack using the discharging circuit.

20. The method of claim 11, further comprising, in response to detecting a fault condition associated with the first battery pack, stopping the charging of the first battery pack using the charging circuit.
